(19) United States
(12) Patent Application Publication
(10) Pub. No.: US 2003/0084118 A1
(43) Pub. Date: May 1, 2003

(54) System and process for storing securely secret information, apparatus and server to be used in such a system and method for distribution of a digital content

(76) Inventors: Pierre Fischer, Paris (FR); Eric Diehl, Liffre (FR)

Correspondence Address: Joseph S Tripoli, Patent Operations, Thomson Multimedia Licensing Inc, CN 5312, Princeton, NJ, 08543-0028, US

(21) Appl. No.: 10/257,343

(22) PCT Filed: Apr. 10, 2001
(86) PCT No.: PCT/EP01/04088

(30) Foreign Application Priority Data
Apr. 11, 2000 (EP) 00401007.0

(51) Int. Cl. G06F 15/16

(52) U.S. Cl. 709/217; 709/229

(57) ABSTRACT

A system for securely storing secret information comprises an apparatus (10; 1) containing the secret information, a device meant to use said secret information to decrypt a digital content and a remote server (20). The apparatus can send the secret information to the server (20) that has means for storing the secret information. A process with the following steps is proposed: initiating a remote communication between the apparatus (10; 1) and the remote server (20); sending the secret information from the apparatus (10; 1) to the server (20); storing the secret information on the server (20). A method for distribution of a digital content is also described.

### FIELD OF THE INVENTION

The invention relates generally to secure storage of secret information and more particularly to a system and a process for securely storing secret information and to an apparatus and a server to be used in said system. The invention also relates to a method for distribution of a digital content.

### BACKGROUND ART

With the advent of digital TV, and copy protection, the access to content will be protected by rights. These rights may have many forms like entitlements, or dedicated decryption keys. The notion of rights might be extended to any secret information. All these type of data have in common that they need to be stored in a safe place.

Today none of the consumer devices has such tamper proof place. The price would be prohibitive. Only smart cards offer sufficient security. Unfortunately the size of memory of smart cards, and thus their storage capability, is limited. Furthermore a smart card can break down, or be lost. So today, once the user mislays his secret data, he will have no simple way to retrieve them. If these data represent user's rights acquired on digital content (for example the right to view a film or to listen to music) it may be prejudicial to the user if he loses these rights he has paid for.

### SUMMARY OF THE INVENTION

The present invention is therefore directed to the problem of finding a way of safely and securely storing secret data to be used by a single device or by a device in a network. Another problem to be solved by the invention is to find a way of retrieving these secret data if the device or the network has lost them.

The invention relates to a system for securely storing secret information to be used by a device wherein said secret information is stored in a remote server. The device may be part of a home network and preferably the secret information is used by said device to access to a digital content.

Therefore, the remote server acts as a bank which maintains in a safe place digital secrets.

The invention proposes an apparatus containing secret information to be used by a device to decrypt a digital content and having means for sending said secret information to a remote server in order to store said information in said remote server, said server being remote from said device.

The invention also proposes a system for securely storing secret information comprising an apparatus containing said secret information, a device meant to use said secret information to decrypt a digital content and a server remote from said apparatus and from said device, wherein said apparatus comprises means for sending said secret information to said server and wherein said server comprises means for storing said secret information.

The apparatus may be part of said device, or may belong to the same home network as said device. In such cases, the apparatus is thereafter called the remote safe gateway. The apparatus may alternatively belong to a local network generating said secret information (i.e. belong to the secret provider).

According to another aspect of the invention, a server for securely storing secret information to be used by a device remote from said server to decrypt a digital content has means for receiving said secret information through a remote communication

A process is proposed for securely storing secret information to be used by a device to decrypt a digital content: this process comprises the steps of:

initiating a remote communication between an apparatus containing said secret information and a server remote from said device;

sending said secret information from said apparatus to said server;

storing said secret information on said server.

The invention also relates to a method for distribution of a digital content to be used by a device comprising the steps of:

encrypting the digital content to thereby generate an encrypted digital content and secret information meant to later decrypt the encrypted digital content;

sending said secret information to a server remote from said device for storing said secret information on said server;

providing means for said device to retrieve said secret information from said server and to decrypt the encrypted digital content with said secret information.

### BRIEF DESCRIPTION OF THE DRAWINGS

FIG. 1 illustrates the general architecture of a system according to the invention.

FIG. 2 illustrates the architecture of a device used in the system of FIG. 1.

FIG. 3 illustrates a process for storing secret information according to a first embodiment of the invention.

FIG. 4 illustrates a process for retrieving a secret information stored according to the process illustrated in FIG. 3.

FIG. 5 illustrates a second embodiment of the invention.

FIG. 6 illustrates a process for storing a secret information in the second embodiment of the invention.

### DESCRIPTION OF THE PREFERRED EMBODIMENTS

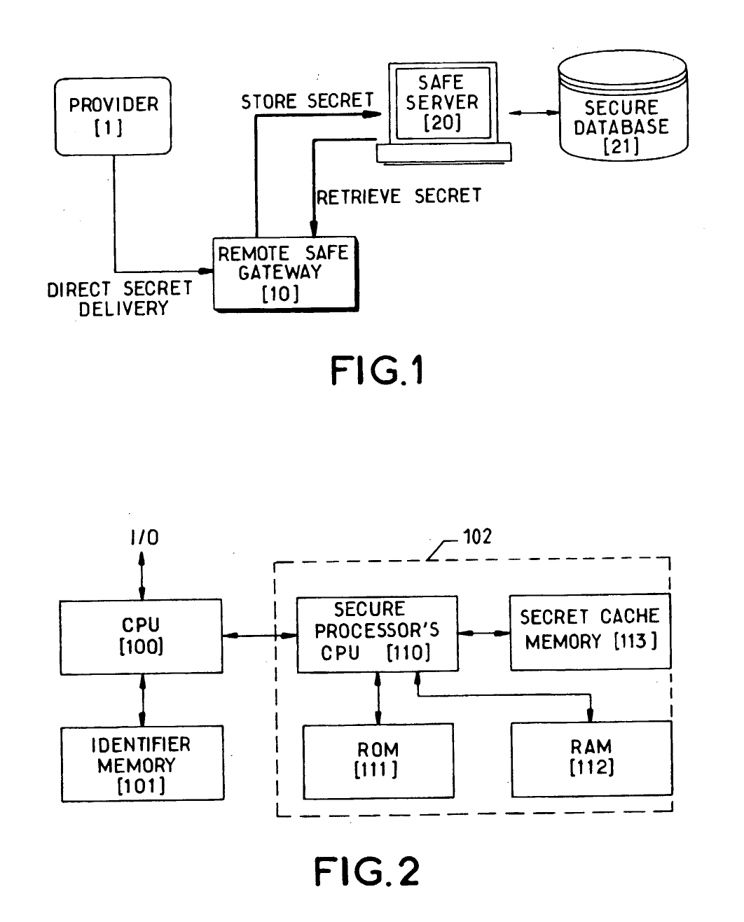

In FIG. 1, we have illustrated a first embodiment of a system according to the invention. In this embodiment, the user has a Set Top Box device 10 (STB) with a return channel such as a PSTN (for “Public Switched Telephone Network”) modem or a cable modem.

We assume that all the information to store securely can be carried to this STB. For instance, we can envisage that a complete home network can benefit from the remote safe facility. In this case, preferably, a unique device of the network will be able to store and retrieve secret information according to the invention. This unique dedicated STB is used as an apparatus called the remote safe gateway. Obviously it could be another type of device, for example a computer.

Through its return channel, each remote safe gateway interacts with a remote server 20 called the remote safe server. The remote server has direct access to its own secure database 21. The secure database will store safely and securely the secret information.

In a preferred embodiment of the system, the secure database will be duplicated at least once in different locations. This will avoid loss of data due to natural or malicious crashes. Nevertheless, only one occurrence of the secure database will be considered in the following in order to simplify the presentation of the invention.

The user receives his secrets from a secret provider 1 which is consider here as having generated the secret information. It may be for example a content provider which provides, with an encrypted content, a secret to decrypt this content.

The secret provider 1 provides the information directly to the remote safe gateway 10. The user may receive information from many secret providers.

The characteristics of the system are as follows:

A user must be identified uniquely. It must not be possible to impersonate him.

A user must be able to transfer the secret digital information stored in his home system to the safe server 20. No information must leak from this transfer. For that purpose, the remote safe gateway 10 is used to make this transfer.

The user must be able to retrieve one, part, or all the information stored in his remote safe. No information must leak from this transaction. For that purpose, the remote safe gateway 10 is also used for this transaction.

There must be no constraint on the format of the stored information.

We will now describe how the system is working.

A first stage of the process consists in the registration of the user. Prior to use the remote safe, the user must sign on the remote safe server's operator. For that purpose, he provides a set of personal information. The definition of these data depends on the operator and is out of the scope of this invention. In return the operator returns a set of secret user identity information (SIᵤₛₑᵣ) used in the next stages. Among this set of information is the unique identifier (IDᵤₛₑᵣ) that thoroughly defines a given user.

The channel used for this communication can be different from the return channel of the remote safe gateway. In any case the transfer of the secret user identity information (SIᵤₛₑᵣ) needs to be secured. There are several possible ways: mailing of a smart card, encrypted information sent through the return channel, . . . In the last case, the decryption key is transferred through a secure separate channel such as phone or post mail.

A second stage of the process consists in the storage of secret information in the safe. This requires several steps.

In a first step, the remote safe gateway authenticates the remote safe server using known authentication methods. If the authentication fails, then the storage operation fails.

In a second step, the remote safe server authenticates the remote safe gateway. If the authentication fails, then the storage operation fails.

In a third step, they define a common session key Kₛₑₛₛᵢₒₙ. This means a remote communication is initiated between the remote safe server and the remote safe gateway.

Then, in a fourth step, the remote safe server creates a unique identifier, InfIDᵤₛₑᵣ_{_{—}}ᵢ for the information i to be stored. InfIDᵤₛₑᵣ_{—i} is unique for each information stored by the user. Its choice is fully under the control of the remote safe server. It can be either a “random” number, or a number dedicated to the user, following a given rule f, so that f(InfIDᵤₛₑᵣ_{_{—}}ᵢ, IDᵤₛₑᵣ)=true

In a fifth step, the remote safe gateway sends the information i to store to the remote safe server. The information i is encrypted using the session key Ksession before being sent. In an optional step, the remote safe gateway encrypts the information i using a secret key of the remote safe gateway before using the session key. Thus, with this optional step, the remote safe server will not have access to the plain text information.

Then, in the last step, the remote safe server decrypts the received information using the session key Ksession and stores it into its secure database.

The transfer may be secured against transmission errors, or message tampering. In that case, the remote safe server checks the integrity of the decrypted message before its eventual storage.

A third stage of the process consists in the retrieval of the secret information from the remote safe server. This operation requires the following steps.

In a first step, the remote safe server authenticates the remote safe gateway. If the authentication fails, then the retrieval operation fails.

In a second step, they define a common session key Ksession.

Then, in a third step, the remote safe gateway provides the remote safe server with the unique identifier of the information to retrieve InfIDuser_i.

In a fourth step, the remote safe server checks the validity of InfIDuser_i. It checks if the corresponding information exists in the database and if this is the case, the remote safe server sends back the requested information to the requesting remote safe gateway in a fifth step. The information is encrypted using the session key Ksession before being sent to the remote safe gateway.

Then, in a last step, the remote safe gateway decrypts the received message using the session key Ksession.

Preferably, the transfer is secured against transmission errors, or message tampering. In that case, the remote safe gateway checks the integrity of the decrypted message before using it.

According to one preferred aspect of the invention, all the operations, except the registration phase, should be transparent to the user. In other words, the retrieval of the stored secrets should be automatic and should not request any interaction from the user.

FIG. 2 illustrates a possible architecture for the remote safe gateway. In this figure, only the elements which are necessary for the understanding of the invention have been represented.

The remote safe gateway has a Central Processing Unit (CPU) 100. It is assumed that the CPU has its own volatile memory and non-volatile memory where its program is stored. In addition, the remote safe gateway has a non-volatile memory space 101 called the identifiers' memory. The CPU 100 can read and write the content of this space.

The remote safe gateway has also a secure processor 102. This secure processor is a tamper proof device that has at least a dedicated CPU 110, a non volatile memory 111 (ROM—Read Only Memory) to store program and persistent data, a volatile memory 112 (RAM—Random Access Memory), and a dedicated non-volatile memory area 113, called the secret cache memory. The secure processor 102 is, in a preferred embodiment, a smart card.

The CPU 100 never handles actual secrets. It handles only information identifiers InfIDuser_i. It maintains a list of the secret information through a list of their corresponding InfIDuser_i. This list is stored in the identifiers' memory. This space needs not to be tamper-proofed. Therefore it is not costly. The size of the identifiers' memory should be chosen to be large enough to store the expected amount of information identifiers.

The secure processor's CPU 110 handles the actual secrets. It stores them in its secret cache memory 113. Unfortunately this space is limited in size due to cost. Therefore it will employ memory-caching techniques that optimize the use of the space. It will store the most recently used secrets and some of the most frequently used secrets.

If the remote safe gateway needs a secret information which is not readily available in the secret cache memory 113, then the secure processor's CPU 110 requests it to the remote safe server.

In one embodiment of the invention, the remote safe gateway is part of a digital home network where other devices are connected. Some of these devices can also handle secrets. In that case they may reproduce the architecture of FIG. 2. Nevertheless, only the remote safe gateway is able to communicate with the remote safe server. The other devices exchange, through secure communication, with the remote safe gateway their secrets to store or to retrieve.

We will now enter into more details of this first embodiment.

Registration of the user.

When signing on, the user receives the secret user identity information as follows:

A unique identifier IDuser.

A pair of public (PUBᵤₛₑᵣ) and private (PRIᵤₛₑᵣ) keys; the remote safe server encrypts with a public key cryptosystem that we will call CS1. RSA (Rivest-Shamir-Adleman public key cryptosystem) could be such a system.

A public key certificate CERTᵤₛₑᵣ signed by the remote safe server using its private signature key PRI_{safe}_{_{—}}_{sign}. The remote safe server signs with a public key cryptosystem that we will call CS2. RSA could be such a system. CS2 can be identical to CS1.

The public key of the remote safe server PUB_{safe}_{_{—}}_{enc} using cryptosystem CS1.

These data must be transferred safely to the user. It is especially important that his private key, PRIᵤₛₑᵣ, is kept secret. He may for example receive these data in a smart card sent to him via mail.

Storage of the secret information.

The format of the message to store is preferably defined as follows:

Info_To_Store = {

InfIDuser_i
Length_clear_text
Clear_Text
Length_secret
for I=0 to Length_secret−1

Secret_data[i]

Checksum

}

where:

InfIDuser_i is a unique identifier of the information stored by the user. This identifier is unique to the user and delivered by the safe server;

Clear_Text is an ASCII text that describes the stored secret information. Its content is user defined. It could be envisaged that the secret provider delivers a default value for this secret;

Length_clear_text defines the length in bytes of Clear_Text;

Secret_data is the secret to store in the remote safe;

Length_secret defines the length in bytes of Secret_data

Checksum is the sum of all previous bytes of the packet.

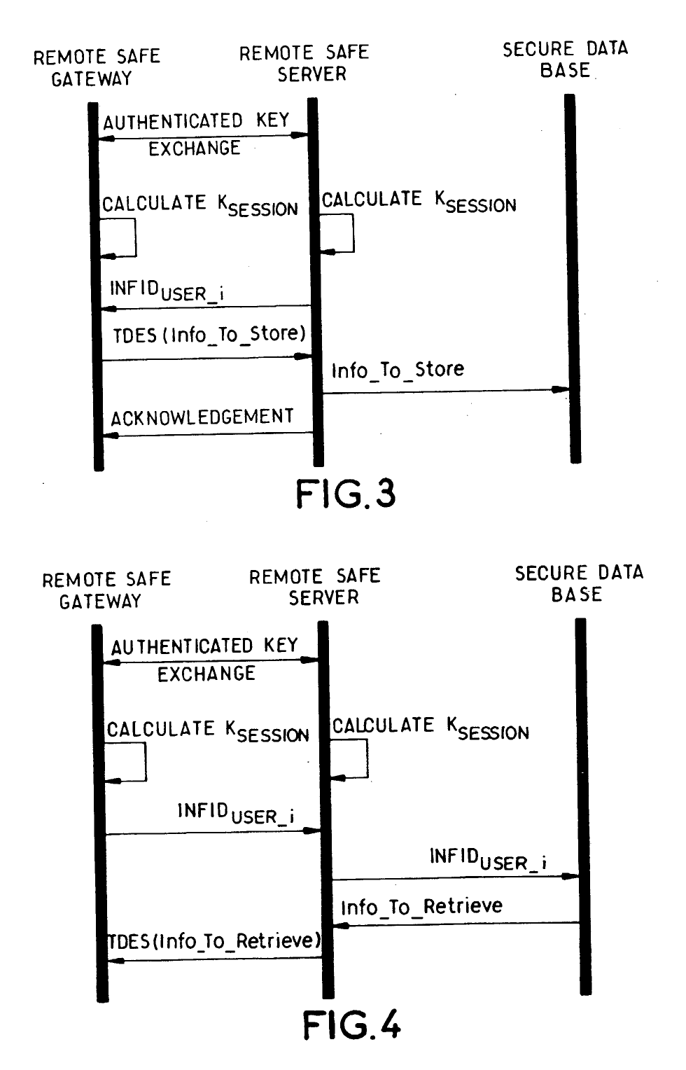

The process for storing a secret information is illustrated in FIG. 3 and explained in the following.

The mutual authentication and key exchange uses the Authenticated DIFFIE HELLMAN Key Exchange Protocol. The protocol generates a common key K_{com}.

The common session key Ksession is the set of the 112 lower bits of the hash of K_{com} through the Secure Hash Algorithm (SHA-1).

The remote safe server defines a new value for the information identifier, InfIDuser_i. It sends it to the remote safe gateway.

The remote safe gateway builds the message Info_To_Store with its secret data and InfIDuser_i. It encrypts it with the Triple DES algorithm using the common session key Ksession It sends the encrypted message to the remote safe server that decrypts it using the common key Ksession.

The remote safe server checks the validity of Checksum. If the received message is valid, the remote safe server sends it to the secure database. If the operation was successful, the remote safe server returns an acknowledgement to the remote safe gateway, else it returns a non-acknowledgement.

Retrieving the secret information.

The process for retrieving a secret information stored in the remote safe server is illustrated by FIG. 4 and will be explained in the following.

The mutual authentication and key exchange uses the Authenticated DIFFIE HELLMAN Key Exchange Protocol. The protocol generates a common key K_{com}.

The common session key Ksession is the set of the 112 lower bits of the hash of K_{com} through the Secure Hash Algorithm (SHA-1).

The remote safe gateway sends the reference of the data to retrieve: InfIDuser_i.

On receipt of the information identifier InfIDuser_i, the remote safe server passes it to the secure database.

The secure database checks if the message exists, i.e., if there is an information, own by the user, that has the right identification. If it is the case, then it returns the requested information Info_To_Retrieve to the remote safe server. The remote safe server encrypts the received data using Triple DES with the session key Ksession and It sends the encrypted message to the remote safe gateway.

The remote safe gateway decrypts the received message using the session key Ksession. It checks the validity of Checksum and if it is valid, the remote safe gateway uses the retrieved secret information Info_To_Retrieve.

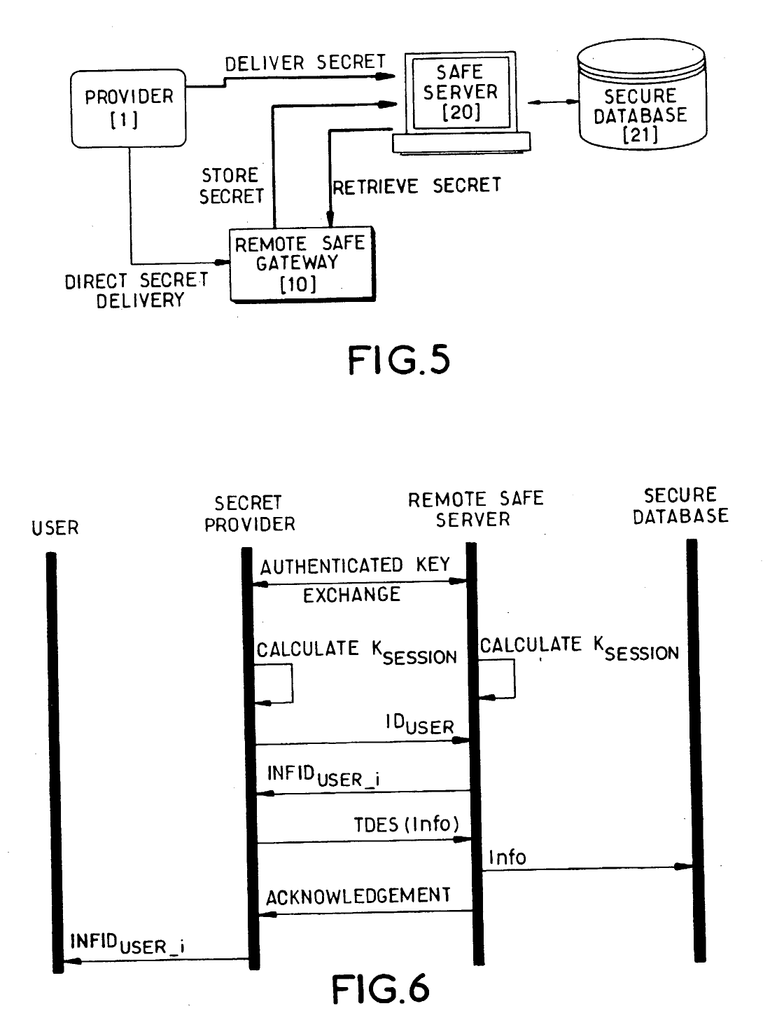

We will now describe a second embodiment of the invention which is illustrated in FIG. 5.

In this embodiment, the secret provider can provide the information directly to the remote safe gateway or by an indirect way using the remote safe server. The user may receive information from many secret providers.

The additional characteristics of the system are as follows:

A third party, known as the secret provider, can deposit a secret to the remote safe server on behalf of a user. No information must leak from this transaction.

It is not possible to impersonate a secret provider.

Once a secret as been deposited by a secret provider, the secret provider has no possible access to it.

A secret provider cannot retrieve any information stored on the account of a user.

Only an authorized secret provider can deposit a secret onto the account of a user.

In this embodiment, the process for the secret provider has two stages:

The first stage consists in the registration of the secret provider. As for the remote safe gateway, the secret provider needs to sign on the remote safe server. He signs on as secret provider. In return, it receives a set of information known as secret provider identity information (SIₚᵣₒᵥ).

The second stage consists in the storage of a secret information on behalf of a user. This stage requires several steps.

In a first step, the secret provider, through an apparatus of a local network of its own, authenticates the remote safe server. If the authentication fails, then the storage operation fails.

In a second step, the remote safe server authenticates the secret provider. If the authentication fails, then the storage operation fails.

In a third step, the remote safe server and the secret provider's apparatus define a common session key Kₛₑₛₛᵢₒₙ.

Then, in a fourth step, the secret provider provides the identity of the user that he is acting for: IDᵤₛₑᵣ.

In a fifth step, the remote safe server creates a unique identifier, InfIDuser_i for the information to be stored. InfIDuser_i is unique for each information stored by the user identified by IDuser. Its choice is fully under the control of the remote safe server. It can be either a “random” number, or a number dedicated to the user, following a given rule.

In a sixth step, the secret provider sends the information to store to the remote safe server. The sent information is encrypted using the session key Kₛₑₛₛᵢₒₙ.

In a last step, the remote safe server decrypts the received information using the session key Kₛₑₛₛᵢₒₙ and stores it into its secure database. The transfer may be secured against transmission errors, or message tampering using known techniques. In that case, the remote safe server checks the integrity of the decrypted message before its eventual storage.

Once the operation was successfully ended, then the secret provider sends the information identifier InfIDuser_i to the corresponding remote safe gateway. The secret provider does not keep any copy of it. Therefore, it is impossible for the secret provider to access any more to the secret information to retrieve it or to modify it.

Details of this second embodiment are explained bellow:

Registration of the secret provider

When signing on, the secret provider receives the following secret provider identity information:

A unique identifier IDₚᵣₒᵥ.

A pair of public (PUBₚᵣₒᵥ) and private (PRIₚᵣₒᵥ) keys; the remote safe server encrypts with the public key cryptosystem CS1.

A public key certificate CERTₚᵣₒᵥ signed by the remote safe server using its private signature key PRI_{safe}_{_{—}}_{sign}_{_{—}}₂; the safe server signs with the public key cryptosystem CS2.

The public key of the remote safe server PUB_{safe}_{_{—}}_{enc}.

These information must be transferred safely to the secret provider. It is especially important that his private key is kept secret

Storage of an information on behalf of a user.

This process, which is illustrated in FIG. 6, is similar to the process described previously in view of FIG. 3. The main differences are:

Prior to exchange the secret information, the secret provider has to identify the user to whom is it depositing. The identification uses the user's unique identifier IDuser.

Once the secret provider successfully stored the information, it sends the reference of the information to the user, that is to its remote safe gateway.

The system if the invention may be applied to a new distribution model. For example, a content provider wants to distribute in a controlled manner a content. This content can be any digital content such as video, MP3 files, software, etc. For that purpose it distributes the content encrypted with an encryption key K_{enc}_{_{—}}_{cont}_{_{—}}ᵢ. To read this encrypted content, the user must have access to the decryption key K_{dec}_{_{—}}_{cont}_{_{—}}ᵢ. The decryption key may be equal to the encryption if we use a symmetric cryptosystem. The user contacts the content provider and buys the right to access the content. Acting as a secret provider, the content provider deposits the decryption key in the user's remote safe. In return the user receives the information identifier of the decryption key.

Another possible application of the system of the invention is a small footprint backup of a jukebox. The jukebox will be a future new type of consumer device. It will probably be successful. Nevertheless with the jukebox, a major risk is introduced: loss of all the contents stored in the jukebox. Currently it is envisaged to use hard disks as storage units. In the field of software, it is well known that regular backup of the hard disk is a safe practice. But it is not reasonable to expect the same feature in a consumer device.

The system of the invention will provide a backup facility based on the remote safe as a new service. For each legally delivered content, the content provider will provide an additional information called a digital purchase proof. The digital purchase proof is the result of a one way cryptographic function using as input parameter a unique identifier of the owned content, and the user identifier IDᵤₛₑᵣ. Instead of backing up all his contents, the user stores in his remote safe all his digital purchase proofs. If he loses one content, the user returns to the content provider the corresponding digital proof. The content provider checks if the digital proof is consistent with the claimed content and the identity of the user. If it is the case, then the content provider sends back to the user a copy of the content.

In conclusion, the invention offers the following advantages:

the possibility to handle in a safe and secure manner a large quantity of secret data without requesting an in-house large tamper-proof space;

a simple new model of distribution of digital content that could fit for IP streaming, or even prerecorded contents;

a small size backup of large library of digital contents.

1. Apparatus containing secret information to be used by a device to decrypt a digital content,
characterised by means for sending said secret information to a remote server (20) in order to store said information in said remote server (20), said server (20) being remote from said device.

2. Apparatus according to claim 1, being part of said device.

3. Apparatus according to claim 1, belonging to the same home network as said device.

4. Apparatus according to claim 1, belonging to a local network (1) generating said secret information.

5. System for securely storing secret information comprising:
an apparatus (10; 1) containing said secret information;
a device meant to use said secret information to decrypt a digital content;
a server (20) remote from said apparatus and from said device,
wherein said apparatus (10; 1) comprises means for sending said secret information to said server (20) and wherein said server (20) comprises means for storing said secret information.

6. System according to claim 5, wherein said apparatus (10) is part of said device.

7. System according to claim 5, wherein said apparatus (10) and said device are connected to a common home network.

8. System according to claim 5, wherein said apparatus (1) belongs to a local network generating said secret information.

9. Server (20) for securely storing secret information to be used by a device to decrypt a digital content, said device being remote from said server (20),
characterised by means for receiving said secret information through a remote communication.

10. Process for securely storing secret information to be used by a device to decrypt a digital content comprising the steps of:
initiating a remote communication between an apparatus (10; 1) containing said secret information and a server (20) remote from said device;
sending said secret information from said apparatus (10; 1) to said server (20);
storing said secret information on said server (20).

11. Method for distribution of a digital content to be used by a device comprising the steps of:
encrypting the digital content to thereby generate an encrypted digital content and secret information meant to later decrypt the encrypted digital content;
sending said secret information to a server (20) remote from said device for storing said secret information on said server (20);
providing means (10) for said device to retrieve said secret information from said server (20) and to decrypt the encrypted digital content with said secret information.
